(19) United States
(12) Patent Application Publication
(10) Pub. No.: US 2025/0103394 A1
(43) Pub. Date: Mar. 27, 2025

(54) DATA PROCESSING METHOD AND DEVICE, AND STORAGE MEDIUM

(71) Applicant: Smarter Silicon (Shanghai) Technologies Co., Ltd., Shanghai (CN)

(72) Inventor: Yong CHEN, Shanghai (CN)

(21) Appl. No.: 18/886,366

(22) Filed: Sep. 16, 2024

(30) Foreign Application Priority Data
Sep. 26, 2023 (CN) 202311260533.9

(51) Int. Cl. G06F 9/50

(52) U.S. Cl. CPC G06F 9/5038

(57) ABSTRACT

A data processing method includes determining a target processing order for processing a plurality of data blocks in data, based on maximum storage capacity of a buffer. The data is divided into the plurality of data blocks for separate processing, and adjacent data blocks in the plurality of data blocks have overlapping data. The method also includes sequentially processing the plurality of data blocks using a neural network based on the target processing order. At least a part of a processing result of a later-processed data block of the plurality of data blocks is a multiplexing of a processing result corresponding to the overlapping data between the later-processed data block and one or more earlier-processed data blocks of the plurality of data blocks, adjacent to the later-processed data block.

### CROSS-REFERENCES TO RELATED APPLICATIONS

This application claims priority to Chinese Patent Application No. 202311260533.9, filed on Sep. 26, 2023, the entire content of which is hereby incorporated by reference.

### FIELD OF THE DISCLOSURE

The present disclosure generally relates to the field of computer technology and, more particularly, relates to a data processing method, a device, equipment, a storage medium, and a program product.

### BACKGROUND

In a digital chip system, the access speed and power consumption of an on-chip random access memory (RAM) may be superior to the access speed and power consumption of an off-chip double data rate synchronous dynamic random access memory (DDR SDRAM).

Due to the limited on-chip RAM capacity in a chip system, when using a neural network for data processing, to reduce the amount of data accessed from an off-chip DDR SDRAM and improve processing efficiency, the data may be generally divided into a plurality of tiles for processing, and the tile data currently in use may be stored in the high-speed on-chip RAM as much as possible. However, even when the data is processed in tiles, the amount of intermediate processing results generated during the data processing process may still pose a challenge to the capacity of the on-chip RAM.

### SUMMARY

One aspect of the present disclosure includes a data processing method. The method includes determining a target processing order for processing a plurality of data blocks in data, based on maximum storage capacity of a buffer. The data is divided into the plurality of data blocks for separate processing, and adjacent data blocks in the plurality of data blocks have overlapping data. The method also includes sequentially processing the plurality of data blocks using a neural network based on the target processing order. At least a part of a processing result of a later-processed data block of the plurality of data blocks is a multiplexing of a processing result corresponding to the overlapping data between the later-processed data block and one or more earlier-processed data blocks of the plurality of data blocks, adjacent to the later-processed data block.

Another aspect of the present disclosure includes a data processing device. The device includes a determination module and a processing module. The determination module is used to determine a target processing order for processing a plurality of data blocks in data, based on maximum storage capacity of a buffer. The data is divided into the plurality of data blocks for separate processing, and adjacent data blocks in the plurality of data blocks have overlapping data. The processing module is used to sequentially process the plurality of data blocks using a neural network based on the target processing order. At least a part of a processing result of a later-processed data block of the plurality of data blocks is a multiplexing of a processing result corresponding to the overlapping data between the later-processed data block and one or more earlier-processed data blocks of the plurality of data blocks, adjacent to the later-processed data block.

Another aspect of the present disclosure includes a non-transitory computer readable storage medium containing computer program that, when being executed, causes at least one processor to perform: determining a target processing order for processing a plurality of data blocks in data, based on maximum storage capacity of a buffer, the data being divided into the plurality of data blocks for separate processing, and adjacent data blocks in the plurality of data blocks having overlapping data; and sequentially processing the plurality of data blocks using a neural network based on the target processing order. At least a part of a processing result of a later-processed data block of the plurality of data blocks is a multiplexing of a processing result corresponding to the overlapping data between the later-processed data block and one or more earlier-processed data blocks of the plurality of data blocks, adjacent to the later-processed data block.

Other aspects of the present disclosure may be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a schematic diagram of data in each neural network layer when the data is processed using a block-based inter-layer fusion technique.

FIG. 2 illustrates a schematic diagram of processing a plurality of data blocks using a neural network.

FIG. 3 illustrates a schematic diagram of a feature map corresponding to each convolutional layer when a convolutional neural network is used to process an input feature map.

FIG. 4 illustrates an implementation flow chart of a data processing method consistent with the disclosed embodiments of the present disclosure.

FIG. 5A illustrates a schematic diagram of processing a plurality of data blocks when a buffer is divided into one multiplexable data buffer area in a data processing method, consistent with the disclosed embodiments of the present disclosure.

FIG. 5B illustrates a schematic diagram of processing a plurality of data blocks when a buffer is divided into two multiplexable data buffer areas in the data processing method, consistent with the disclosed embodiments of the present disclosure.

FIG. 5C illustrates a schematic diagram of processing a plurality of data blocks when a buffer is divided into three multiplexable data buffer areas in the data processing method, consistent with the disclosed embodiments of the present disclosure.

FIG. 5D illustrates a schematic diagram of processing a plurality of data blocks when a buffer is divided into five multiplexable data buffer areas in the data processing method, consistent with the disclosed embodiments of the present disclosure.

FIG. 6 illustrates an implementation flow chart of processing an earlier-processed data block in a data processing method, consistent with the disclosed embodiments of the present disclosure.

FIG. 7 illustrates a schematic diagram showing a corresponding relationship between a quantity of multiplexable data buffers and a data multiplexing rate in a data processing method, consistent with the disclosed embodiments of the present disclosure.

FIG. 8 illustrates a schematic diagram of a corresponding relationship between a maximum storage capacity of a buffer and an amount of computing saved in a data processing method consistent with the disclosed embodiments of the present disclosure.

FIG. 9 illustrates a schematic diagram of a corresponding relationship between a maximum storage capacity of a buffer and an amount of access to an off-chip memory saved in a data processing method, consistent with the disclosed embodiments of the present disclosure.

FIG. 10 illustrates a schematic structural diagram of a data processing device consistent with the disclosed embodiments of the present disclosure.

### DETAILED DESCRIPTION

To make the objectives, technical solutions and advantages of the present disclosure clearer and more explicit, the present disclosure is described in further detail with accompanying drawings and embodiments. It should be understood that the specific exemplary embodiments described herein are only for explaining the present disclosure and are not intended to limit the present disclosure.

It should be noted that in the present disclosure, relational terms such as “first” and “second” are only configured to distinguish one entity or operation from another entity or operation, and do not necessarily require or imply that such actual relationship or sequence exists between these entities or operations. Terms “comprise”, “include” or any other variations thereof are intended to cover a non-exclusive inclusion. A process, method, article, or apparatus that includes a series of elements includes not only the series of elements, but also other elements not expressly listed, or elements inherent to such a process, method, article, or apparatus. Without further limitation, an element defined by a statement like “comprises a . . . ” does not exclude the presence of additional identical elements in a process, method, article, or apparatus that includes the foregoing element.

It should be noted that relative arrangements of components and operations, numerical expressions and numerical values set forth in exemplary embodiments are for illustration purpose only and are not intended to limit the present disclosure unless otherwise specified. Techniques, methods and apparatus known to the skilled in the relevant art may not be discussed in detail, but these techniques, methods and apparatus should be considered as a part of the specification, where appropriate.

In existing technology, to solve the problem that the on-chip buffer capacity is small and insufficient to meet data access needs, the input data may be divided into a plurality of blocks (tiles) and processed using inter-layer fusion technology. That is, the data generated by each layer in a neural network may be timely used by a next layer, and the data generated between layers may be stored in an on-chip random access memory (RAM) without accessing an off-chip double data rate synchronous dynamic random-access memory (DDR SDRAM).

However, in the block-based (tile-based) inter-layer fusion technology, overlapping data may exist between adjacent data blocks. FIG. 1 illustrates a schematic diagram of data in each neural network layer when the data is processed using a block-based inter-layer fusion technique. As shown in FIG. 1, an input feature map 101 is processed by a first convolutional layer to obtain a first intermediate feature map 102. The first intermediate feature map 102 is processed by the second convolutional layer to obtain a second intermediate feature map 103. The second intermediate feature map 103 is processed by a third convolutional layer to obtain an output feature map 104. To obtain an output feature map of a specified size and make each convolutional layer to extract features from the input feature map or intermediate feature map according to a specified feature extraction precision, it may be necessary to set a moving step size of the convolution kernel on the feature map for each convolutional layer, that is, a speed at which the convolution kernel moves on the feature map. For example, when the step size is 1, the convolution kernel moves one pixel horizontally or vertically at a time; when the step size is 2, the convolution kernel moves two pixels horizontally or vertically at a time; and so on. In this way, different amounts of overlapping data may be generated between two adjacent data blocks, and it may be seen from the above description that the step size is inversely proportional to the amount of overlapping data.

As shown in FIG. 1, in the input feature map 101, there is overlapping input data between two adjacent data blocks (for example, the area marked by diamonds in the input feature map 101). In the first intermediate feature map 102 and the second intermediate feature map 103, there is overlapping intermediate data between two adjacent data blocks (for example, the area marked with diamonds in the first intermediate feature map 102 and the second intermediate feature map 103). The overlapping intermediate data is also the processing result of the overlapping data of a previous convolutional layer. As may be seen from FIG. 1, the overlapping data appears in an inverted pyramid shape. Moreover, the amount of overlapping data is directly proportional to the number of data blocks and the number of convolutional layers.

In the inter-layer fusion scenario, the data of the input feature map 101 needs to be read from the off-chip DDR SDRAM, and the intermediate layer needs to be calculated through the network layer. As such, the increase in overlapping data may not only lead to an increase in access to off-chip DDR SDRAM, but also lead to an increase in the amount of computation at the network layer.

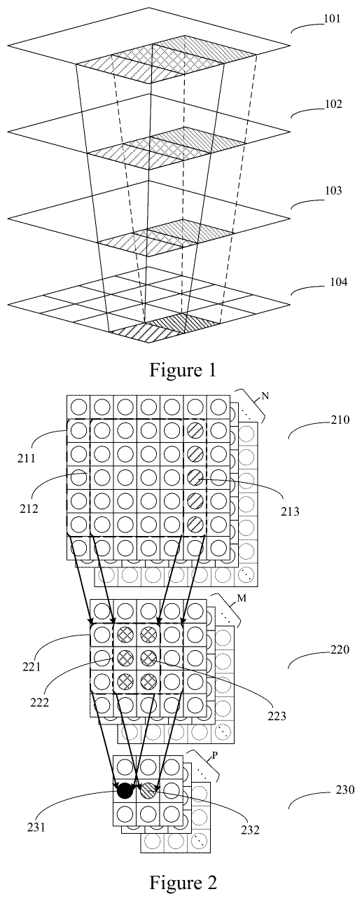

FIG. 2 illustrates a schematic diagram of processing a plurality of data blocks using a neural network. As shown in FIG. 2, in a convolutional neural network (CNN) containing two convolutional layers, after the input feature map 210 is input into the first convolutional layer, an intermediate feature map 220 is output, and after the intermediate feature map 220 is input into the second convolutional layer, an output feature map 230 is output. The input feature map 210 includes data block 211 and data block 212. Data block 211 and data block 212 include overlapping data of 4 columns×5 rows. After data block 211 is processed by the first convolutional layer and the second convolutional layer, data block 221 and data block 231 are obtained respectively. After the data block 212 is processed by the first convolutional layer and the second network layer, the data block 222 and the data block 232 are obtained respectively. In addition, there is overlapping data of 2 columns×3 rows between the data block 221 and the data block 222.

Taking the overlapping data 223 (data represented in a grid form) in the intermediate feature map 220 as an example, by assuming that the convolution kernel size of the CNN is K×K, where K=3, and the filter includes C channels, where C=64, the amount of computation required for the overlapping data 223 in the intermediate feature map 220 is K×K×C=3×3×64=576. It may be seen that the calculation amount of overlapping output data is 576. The computational cost of the entire calculation process for the initial input data may be large.

In this regard, the present disclosure proposes a solution that may employ an overlapping multiplexing buffer (overlap reuse buffer). That is, the overlapping data is stored in an on-chip multiplexing buffer. When calculating the next data block, the overlapping data does not need to be read from the off-chip DDR SDRAM or calculated again. The overlapping data may be directly read from the multiplexing buffer.

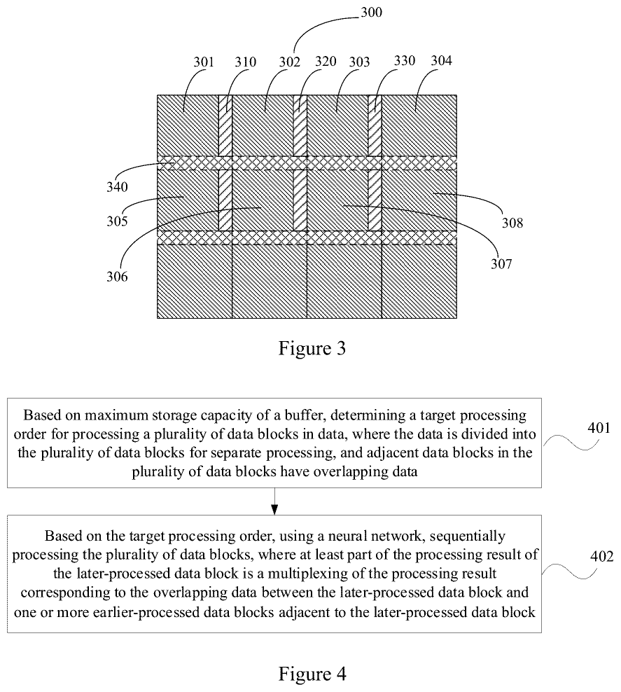

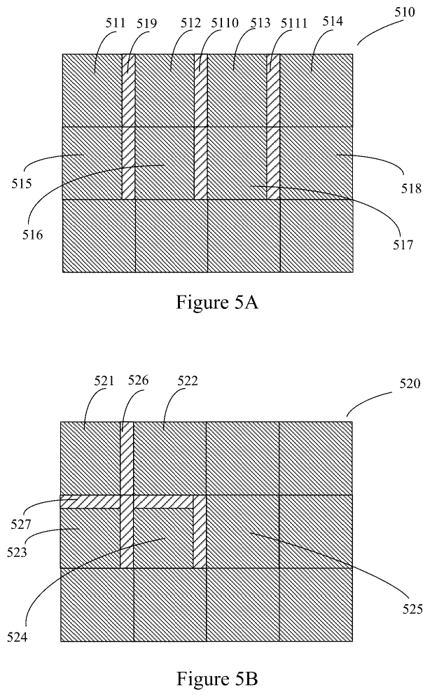

FIG. 3 illustrates a schematic diagram of a feature map corresponding to each convolutional layer when a convolutional neural network is used to process an input feature map. As shown in FIG. 3, for a plurality of data blocks processed in a convolutional layer, according to a conventional convolution operation order, the plurality of data blocks is usually calculated from left to right. That is, first, a plurality of convolutional layers of the convolutional neural network is used to process data block 301 in sequence, and then the plurality of convolutional layers is used to process data block 302 in sequence. After that, data block 303, data block 304, data block 305, data block 306, data block 307 and data block 308 are processed in sequence according to the arrangement order. In this way, when the data in data block 301 is processed by using the plurality of convolutional layers in sequence, for each convolutional layer, the processing result of the overlapping data 310 between data block 301 and data block 302 is stored in the buffer. Afterwards, when data block 302 is processed by using the plurality of convolutional layers in sequence, data block 302 may directly multiplex the processing result of the overlapping data 310 stored in the buffer. Simultaneously, the processing result of the overlapping data 310 is deleted from the buffer, and the processing result of the overlapping data 320 between data block 302 and data block 303 is stored in the buffer, such that the processing result of the overlapping data 320 may be directly multiplexed when data block 303 is processed subsequently.

In this way, when data block 305 is calculated, since the multiplexing buffer does not store the overlapping data 340 between data block 301 and data block 305, the processing result of the overlapping data between the data block 305 and the data block 306 is stored in the buffer so as to be multiplexed when data block 306 is processed.

It may be seen that, in existing technology, in the data-block based inter-layer fusion technology, among a plurality of data blocks, only the overlapping data between two horizontally adjacent data blocks may be multiplexed. That is, overlapping data 310 between data block 301 and data block 302 may be multiplexed, overlapping data 320 between data block 302 and data block 303 may be multiplexed, and so on. However, overlapping data between two vertically adjacent data blocks (i.e., the data represented by the dotted box in FIG. 3), for example, the overlapping data between data block 301 and data block 305, may not be multiplexed. As a result, the overlapping data between the plurality of data blocks may not be fully utilized.

The present disclosure provides a data processing method. Based on maximum storage capacity of a buffer, the data processing method determines a target processing order for processing a plurality of data blocks in the data. Then, based on the target processing order, the plurality of data blocks is processed in sequence using a neural network. At least part of the processing result of a later-processed data block is a multiplexing of the processing result corresponding to the overlapping data between the later-processed data block and at least one earlier-processed data block adjacent to the later-processed data block. In this way, by determining a target processing order and performing convolution processing on the plurality of data blocks according to the target processing order, the multiplexing rate of overlapping data between the plurality of data blocks may be improved.

The data processing method provided by the present disclosure may be executed by a processor of a computer device. The computer device may refer to devices with data processing capabilities, such as servers, laptops, tablet computers, desktop computers, smart TVs, set-top boxes, mobile devices (e.g., mobile phones, portable video players, personal digital assistants, dedicated messaging devices, portable gaming devices), etc.

FIG. 4 illustrates an implementation flow chart of a data processing method consistent with the disclosed embodiments of the present disclosure. As shown in FIG. 4, the method includes processes S401 to S402.

Process S401, based on maximum storage capacity of a buffer, determining a target processing order for processing a plurality of data blocks in data. The data may be divided into the plurality of data blocks for separate processing, and adjacent data blocks in the plurality of data blocks may have overlapping data.

The main body of the buffer is a storage array composed of storage bodies. Outside the storage array is the glue logic. The glue logic may include a series of merging, selection, and register operation or bus protocol conversion logic, and finally outputs to external units or buses.

In some embodiments, the buffer may include a high-speed static random access memory (SRAM) or a dynamic random access memory (DRAM) and corresponding control logic. The buffer may be provided with data, address and control buses, and random access may be realized.

In some embodiments, a very-high-speed integrated circuit hardware description language (VHDL) may be used. System resources of field programmable gate array (FPGA) may be utilized to design and implement an integrated high-speed synchronous buffer. The buffer implemented in this way may not only provide data buffering, but also realize synchronous transmission of data at two ends of the bus interface through read and write operations on the buffer. Accordingly, data transmission efficiency may be improved.

In some embodiments, the buffer refers to a high-speed on-chip buffer integrated on a chip. Data refers to any type of data that may be processed using a neural network. In some embodiments, the data may include at least one of image data, audio data, and video data, which may be processed by a neural network after being quantized. The present disclosure does not limit a specific type of data.

In some embodiments, the data may include at least one of the initial data input into the first network layer of the neural network, and the intermediate data generated after being processed by the network layers of the neural network.

The plurality of data blocks refers to a plurality of data blocks obtained by dividing the data using the data-block based inter-layer fusion technology. In addition, to improve the integrity of data processing and obtain output data of a specified size, there is overlapping data between each division boundary of adjacent data blocks in the plurality of data blocks. After the data is divided into the plurality of data blocks, when each data block is processed by using at least one network layer, an intermediate processing result corresponding to each data block is generated in each network layer.

The processing order refers to an order in which the plurality of data blocks is processed using a neural network. As shown in FIG. 3, the data processing may be performed in a horizontal sequential manner, that is, data blocks 301 to 308 may be processed in sequence. The plurality of data blocks may also be processed in other processing orders, such as data block 301, data block 302, data block 305, data block 306, data block 303, data block 304, data block 307, and data block 308.

The target processing order is a processing order determined from a plurality of processing orders for the plurality of data blocks, and the processing order may achieve a desired processing effect. In some embodiments, the target processing order is a processing order among the plurality of processing orders, which may make the neural network to have the highest multiplexing rate of processing results of overlapping data in the process of processing the data. In other embodiments, the target processing order is a processing order among the plurality of processing orders that may make the neural network to process the data with the highest efficiency.

To obtain the desired processing effect, in the present disclosure, the target processing order for processing the plurality of data blocks may be determined based on the maximum storage capacity of the buffer. That is, the target processing order for processing the plurality of data blocks may be determined by determining the data amount of the processing results of the overlapping data that may be stored in the buffer.

Process S402, based on the target processing order, using a neural network, sequentially processing the plurality of data blocks. At least part of the processing result of the later-processed data block is a multiplexing of the processing result corresponding to the overlapping data between the later-processed data block and at least one earlier-processed data block adjacent to the later-processed data block. The neural network refers to a computational model that may perform data processing.

In some embodiments, the neural network includes a CNN, which includes a convolutional layer, a pooling layer, and a full connection layer. The convolutional layer is a core component of the CNN. A function of the convolutional layer is to extract features from the input image, and output feature maps, activation maps or convolution features. The pooling layer may perform dimensionality reduction processing on the feature map without losing important information, thereby reducing the number of parameters of the feature map, improving the calculation speed, and increasing the receptive field. The full connection layer is configured to nonlinearly combine the extracted features to obtain the output. In some embodiments, the network layer used to process data in the present disclosure may include any one of the convolutional layer and the pooling layer.

The plurality of data blocks may be processed sequentially using the neural network according to the target processing order. For example, as shown in FIG. 2, in one embodiment, the CNN includes two convolutional layers. According to the target processing order, the processing order of data block 211 included in the input feature map 210 is before the processing order of data block 212. When using the CNN to process data block 211 and data block 212, first, the first convolutional layer and the second convolutional layer of the CNN may be used to process data block 211 in sequence to obtain an output data block 231 corresponding to data block 211. Then, the data block 212 is processed in sequence using the first convolutional layer and the second convolutional layer of the CNN to obtain an output data block 232 corresponding to the data block 212.

As may be seen from FIG. 2, there are 5 rows×4 columns of overlapping data between data block 211 and data block 212, and there are 3 rows×2 columns of overlapping data between data block 221 and data block 222. Accordingly, after data block 211 is processed by using the CNN, the processing result of the overlapping data between data block 211 and data block 212 may be stored in the buffer. When data block 212 is subsequently processed, the processing result of the overlapping data may be obtained from the buffer, as the processing result corresponding to the data in data block 212 that overlaps with data block 211. That is, when processing data block 212, the processing result corresponding to the overlapping data between data block 211 and data block 212 may be multiplexed.

In the data processing method provided in the present disclosure, the target processing order for processing the plurality of data blocks in the data may be determined based on the maximum storage capacity of the buffer. Based on the target processing order, the plurality of data blocks may be processed in sequence using a neural network. At least part of the processing result of the later-processed data block is a multiplexing of the processing result corresponding to the overlapping data between the later-processed data block and at least one earlier-processed data block adjacent to the later-processed data block. Thus, on one hand, in the process of processing the plurality of data blocks, at least part of the processing result of the later-processed data block is a multiplexing of the processing result corresponding to the overlapping data between the later-processed data block and at least one earlier-processed data block adjacent to the later-processed data block. Accordingly, repeated calculations of the overlapping data between adjacent data blocks may be reduced, and the purpose of saving computing resources may be achieved. In addition, the number of times of accessing data from the off-chip memory may be reduced, and the data processing speed may thus be increased. On the other hand, the target processing order of the plurality of data blocks may be determined based on the maximum storage capacity of the buffer. That is, the processing order of the plurality of data blocks may be determined by determining the amount of processing results corresponding to the overlapping data that may be stored in the buffer. Accordingly, the multiplexing rate of the processing results of overlapping data may be improved, computing efficiency may be improved, and computing resources may be saved.

In some embodiments, the neural network includes a plurality of network layers, and the plurality of data blocks include a plurality of initial data blocks. The network layer refers to a neural layer that processes data, for example, a neural layer in a hidden layer of the neural network described above. In some embodiments, the neural network may include a convolutional neural network including at least one convolutional layer.

In the above process S402, the plurality of data blocks may be processed sequentially. Process S402 may be achieved by following operations.

For each of the initial data blocks, the plurality of network layers is used to process the initial data blocks in sequence to obtain a processing result corresponding to the initial data block at each of the network layers. Adjacent initial data blocks may have overlapping data between the processing results corresponding to each network layer. In one embodiment, inter-layer fusion technology may be used to process the plurality of data blocks.

When processing the plurality of initial data blocks, first, the earlier-processed initial data block is processed using the plurality of network layers in sequence to obtain the processing result corresponding to the earlier-processed initial data block at each network layer. Then, the later-processed initial data block is processed using the plurality of network layers in sequence to obtain the processing result corresponding to the later-processed initial data block at each network layer. Meanwhile, adjacent initial data blocks may have overlapping data between the processing results corresponding to each network layer.

In some embodiments, the neural network includes at least one network layer. In some embodiments, the above process S401 may be implemented by the following processes S4011 to S4013.

Process S4011, determining the amount of multiplexable data corresponding to the process result multiplexed by a data block and an adjacent data block in the plurality of data blocks. The multiplexable data amount represents a sum of the data amounts corresponding to the processing result of the overlapping data corresponding to the data block and the adjacent data block at each the network layer.

As may be seen from FIG. 2, the overlapping data between each data block in the plurality of data blocks and the adjacent data block may be the data close to the boundary of the data block. For example, in the input feature map 210, the overlapping data of the data block 211 and the data block 212 is the data located on the right side of the data block 211 (i.e., the data of 5 rows×4 columns on the right side of the data block 211 in FIG. 2). After being processed by the first convolutional layer, in the intermediate feature map 220, the overlapping data of the processing result 221 corresponding to the data block 211 and the processing result 222 corresponding to the data block 212 is still the data located on the right side of the data block 221 (i.e., the 3 rows×2 columns of data on the right side of the data block 221 in FIG. 2).

The multiplexable data amount is the sum of the data amounts corresponding to the processing results of the overlapping data corresponding to the one data block and the adjacent data blocks at each network layer. Taking the data block 211 and the data block 212 adjacent to the data block 211 in FIG. 2 as an example, the multiplexable data amount refers to a sum of the amount of data corresponding to the processing result of the 5 rows×4 columns of overlapping data on the right side of the data block 211 in the input feature map 210 and the amount of data corresponding to the processing result of the 3 rows×2 columns of overlapping data on the right side of the data block 221.

Process S4012, based on the maximum storage capacity and the multiplexable data amount, dividing the buffer into at least one multiplexable data buffer area. When the later-processed data block multiplexes at least part of the processing result of an adjacent earlier-processed data block, it is necessary to store the at least part of the processing result of the adjacent earlier-processed data block. As such, based on the maximum storage capacity of the buffer and the multiplexable data amount, that is, the sum of the data amounts corresponding to the processing result of the overlapping data corresponding to the data block and the adjacent data block at each network layer, the buffer is divided into at least one multiplexable data buffer area.

In some embodiments, the dividing method of the buffer may be determined based on a result of dividing the maximum storage capacity by the amount of multiplexable data. For example, when the result of dividing the maximum storage capacity by the amount of multiplexable data is greater than 1 and less than 2, there is no need to divide the buffer. That is, the buffer may be used as the multiplexable data buffer area. When the result of dividing the maximum storage capacity by the amount of multiplexable data is greater than 2 and less than 3, the buffer may be divided into two multiplexable data buffer areas, and the capacity of each multiplexable data buffer area is greater than the amount of multiplexable data. As such, the sum of the data amounts corresponding to the processing results of the overlapping data corresponding to the data block and the adjacent data block at each network layer may be stored.

In some embodiments, the multiplexable data amount may be weighted to obtain a weighted multiplexable data amount. Then, the dividing method of the buffer may be determined based on the result of dividing the maximum storage capacity by the weighted multiplexable data amount.

Step S4013, determining the target processing order for processing the plurality of data blocks in the data, based on the number of the at least one multiplexable data buffer area. According to the number of at least one multiplexable data buffer area obtained by dividing the buffer, the number of multiplexable data blocks that may be buffered in the process of processing the plurality of data blocks may be determined. The target processing order for processing the plurality of data blocks may thus be determined.

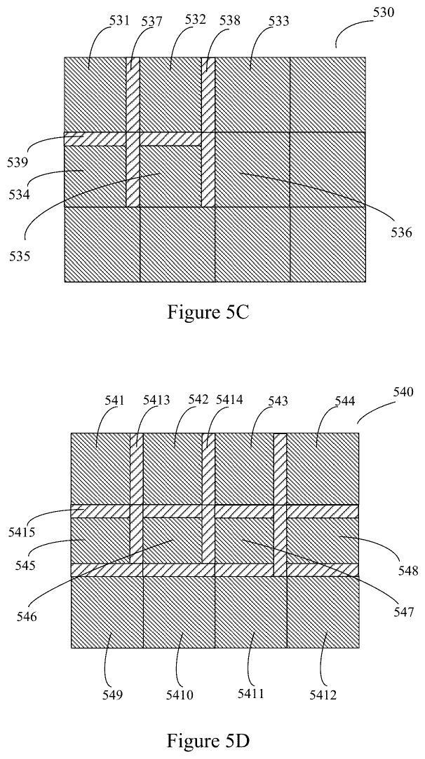

FIG. 5A illustrates a schematic diagram of processing a plurality of data blocks when a buffer is divided into one multiplexable data buffer area in a data processing method. FIG. 5B illustrates a schematic diagram of processing a plurality of data blocks when a buffer is divided into two multiplexable data buffer areas in the data processing method. FIG. 5C illustrates a schematic diagram of processing a plurality of data blocks when a buffer is divided into three multiplexable data buffer areas in the data processing method. FIG. 5D illustrates a schematic diagram of processing a plurality of data blocks when a buffer is divided into five multiplexable data buffer areas in the data processing method. Taking the case where the data includes 12 data blocks as an example, referring to FIGS. 5A, 5B, 5C and 5D, the target processing order determined when the buffer is divided into different numbers of multiplexable data buffer areas is described below.

FIG. 5A shows the processing order of the plurality of data blocks when the buffer is divided into one multiplexable data buffer area. The buffer may only store one multiplexable data block. To multiplex as many processing results corresponding to overlapping data as possible, the processing results corresponding to the overlapping data between two horizontally adjacent data blocks are multiplexed, each data block is processed in sequence from left to right.

In FIG. 5A, the data shown with sparser shadows is the overlapping data between two adjacent data blocks. For example, data 519 is overlapping data between data block 511 and data block 512. That is, data block 511 includes overlapping data 519, and data block 512 includes overlapping data 519. Similarly, data block 512 also includes overlapping data 5110, data block 513 includes overlapping data 5110 and overlapping data 5111, and data block 514 includes overlapping data 5111, and so on.

For example, the overlapping multiplexable data between the data block 511 and the data block 512 is the overlapping data 519. When data processing is performed on the data block 511, the processing result of the overlapping data 519 is stored in the buffer. When data processing is performed on the data block 513, the processing result of the overlapping data 519 may be obtained from the buffer and used as the processing result of the overlapping data 519 in the data block 512. As such, when data block 512 is processed, the processing result corresponding to the data block 519 in the data block 511 may be directly multiplexed. Since the data block 519 is not reprocessed, the computing resources may be saved.

Similarly, when processing the data block 512, the processing result of the overlapping data 519 stored in the buffer is deleted, and the processing result of the overlapping data 5110 between the data block 512 and the data block 513 is saved into the buffer for multiplexing by the data block 513.

When processing the data block 513, the processing result of the overlapping data 5110 between the data block 512 and the data block 513 stored in the buffer is deleted, and the processing result of the overlapping data 5111 between the data block 513 and the data block 514 is stored into the buffer for multiplexing by the data block 514.

When processing data block 514, since data block 514 is only adjacent to data block 513, the data block 514 may directly multiplex the processing result of the overlapping data between the data block 513 and the data block 514 stored in the buffer.

During processing of data blocks 515, 516, 517 and 518, the multiplexing method of the processing results of the overlapping data may be same as the above-mentioned multiplexing method of the processing results of the overlapping data for the data blocks 511 to 514, and will not be elaborated here.

It may be learnt from above descriptions that, when the buffer may only store one multiplexable data block, regarding the overlapping data between each data block and adjacent data blocks (including horizontally overlapping data between adjacent data blocks in the horizontal direction and vertically overlapping data between adjacent data blocks in the vertical direction), only the horizontally overlapping data may be multiplexed, and the vertically overlapping data may not be multiplexed.

FIG. 5B shows a processing order of the plurality of data blocks when the buffer is divided into two multiplexable data buffer areas. In one embodiment, the buffer is divided into two multiplexable data buffer areas, for example, a first buffer area and a second buffer area. When determining the target processing order of the plurality of data blocks, the processing results corresponding to two overlapping data may be stored simultaneously.

As shown in FIG. 5B, the data blocks shown with sparser shading are the overlapping data between adjacent data blocks. For example, data 526 is overlapping data between data block 521 and data block 522. That is, data block 521 includes overlapping data 526, and data block 522 also includes data 526. Data 527 is overlapping data between data block 521 and data block 523. That is, data block 521 includes overlapping data 527, and data block 523 also includes overlapping data 527, and so on.

In some embodiments, as shown in FIG. 5B, for the upper left four data blocks in the plurality of data blocks of data 520, data processing may be performed in an order of data block 521, data block 522, data block 523, and data block 524.

In some embodiments, when data block 521 is processed, the processing result of the overlapping data between data block 521 and data block 522 is stored in the first buffer area. The processing result of the overlapping data block between the data block 521 and the data block 523 is stored in the second buffer area.

When processing the data block 522, the processing result in the first buffer area may be multiplexed. Then, the processing result in the first buffer area may be deleted, and the processing result of the overlapping data between the data block 522 and the data block 524 is stored in the first buffer area.

When processing data block 523, the processing result stored in the second buffer area may be multiplexed. Then, the processing result stored in the second buffer area may be deleted, and the processing result of the overlapping data between the data block 523 and the data block 524 is stored in the second buffer area.

When processing the processing data block 524, the processing result in the first buffer area and the processing result in the second buffer area may be multiplexed. Then, the processing result stored in the first buffer area or the processing result stored in the second buffer area may be deleted. The processing result of the overlapping data between the data block 524 and the data block 525 may be stored in the first buffer area or the second buffer area.

In this way, when the buffer is divided into two multiplexable data buffer areas, the four data blocks in the upper left corner of FIG. 5B may multiplex the processing results of the five overlapping data blocks.

FIG. 5C shows a corresponding target processing order when the buffer is divided into three multiplexable data buffer areas. In one embodiment, since the buffer is divided into three multiplexable data buffer areas, for example, a third buffer area, a fourth buffer area, and a fifth buffer area. When determining the target processing order of a plurality of data blocks, it may be designed to store the processing results of three overlapping data simultaneously.

As shown in FIG. 5C, the data shown with sparser shading is the overlapping data between adjacent data blocks. For example, data block 537 is the overlapping data between data block 531 and data block 532. That is, data block 531 includes overlapping data 537, and data block 532 also includes data 537. Data 538 is the overlapping data between data block 532 and data block 533. That is, data block 532 includes overlapping data 538, and data block 533 also includes data 538. Data block 539 is the overlapping data between data block 531 and data block 534. That is, data block 531 includes overlapping data 539, and data block 534 also includes data 539, and so on.

In some embodiments, as shown in FIG. 5C, for the upper left four data blocks in the plurality of data blocks of data 530, data processing may be performed in an order of data block 531, data block 532, data block 534, and data block 535.

In some embodiments, when processing data block 531, the processing result of the overlapping data between the data block 531 and the data block 532 is stored in the third buffer area, and the processing result of the overlapping data between the data block 531 and the data block 534 is stored in the fourth buffer area.

When processing data block 532, the processing result stored in the third data buffer area may be multiplexed. Then, the processing result in the third buffer area may be deleted, and the processing result of the overlapping data between the data block 532 and the data block 533 may be stored in the third buffer area, and the processing result of the overlapping data between the data block 532 and the data block 535 may be stored in the fifth buffer area.

When processing data block 534, the processing result stored in the fourth buffer area may be multiplexed. Then, the processing result stored in the fourth buffer area may be deleted, and the processing result of the overlapping data between the data block 534 and the data block 535 may be stored in the fourth buffer area.

When processing data block 535, the processing result stored in the fourth buffer area and the processing result stored in the fifth buffer area may be multiplexed. Then, the processing result in the fourth buffer area or the fifth buffer area may be deleted, and the processing result of the overlapping data between the data block 535 and the data block 536 may be stored in the fourth buffer area or the fifth buffer area.

In this way, when the buffer is divided into three multiplexable data buffer areas, the four data blocks in the upper left corner of FIG. 5C may multiplex the processing results of the six overlapping data blocks.

FIG. 5D shows a corresponding target processing order when the buffer is divided into five multiplexable data buffer areas. In one embodiment, the buffer is divided into five multiplexable data buffer areas, for example, the sixth buffer area, the seventh buffer area, the eighth buffer area, the ninth buffer area and the tenth buffer area. When determining the target processing order of the plurality of data blocks, it may be designed to store five multiplexable data blocks simultaneously.

As shown in FIG. 5D, data shown with sparser shading is overlapping data between adjacent data blocks. For example, data block 5413 is overlapping data between data block 541 and data block 542. That is, data block 541 includes overlapping data 5413, and data block 542 also includes data 5413. Data 5414 is the overlapping data between data block 542 and data block 543. That is, data block 542 includes overlapping data 5414, and data block 543 also includes data 5414. Data block 5415 is the overlapping data between data block 541 and data block 544. That is, Data block 541 includes overlapping data 5415, and data block 544 also includes data 5415, and so on.

In some embodiments, as shown in FIG. 5D, the eight data blocks in the upper two rows among the plurality of data blocks of data 540 may be processed in the order of data block 541, data block 542, data block 543, data block 544, data block 545, data block 546, data block 547 to data block 548.

In some embodiments, when processing data block 541, the processing result of overlapping data between data block 541 and data block 542 may be stored in the sixth buffer area, and the processing result of overlapping data between data block 541 and data block 545 may be stored in the seventh buffer area.

When processing the data block 542, the processing result stored in the sixth buffer area may be multiplexed. Simultaneously, the processing result of the overlapping data between the data block 542 and the data block 543 may be stored in the eighth buffer area, and the processing result of the overlapping data between the data block 542 and the data block 546 may be stored in the ninth buffer area.

When processing data block 543, the processing result in the eighth buffer area may be multiplexed. Then, the processing result of the overlapping data between the data block 543 and the data block 547 may be stored in the tenth buffer area, the processing result in the sixth buffer area may be deleted, and the processing result of the overlapping data between the data block 543 and the data block 544 may be stored in the sixth buffer area.

When processing the data block 544, the processing result in the sixth buffer area may be multiplexed. Then, the processing result in the eighth buffer area may be deleted, and the processing result of the overlapping data between the data block 544 and the data block 548 may be stored in the eighth buffer area.

When processing data block 545, the processing result in the seventh buffer area may be multiplexed. Then, the processing result in the sixth buffer area may be deleted, and the processing result of the overlapping data between the data block 545 and the data block 546 may be stored in the sixth buffer area. The processing result in the seventh buffer area may be deleted, and the processing result of the overlapping data between the data block 545 and the data block 549 may be stored in the seventh buffer area.

When processing data block 546, the processing result in the sixth buffer area and the ninth buffer area may be multiplexed. Then, the processing result in the sixth buffer area may be deleted, and the processing result of the overlapping data between the data block 546 and the data block 547 may be stored in the sixth buffer area. The processing result in the ninth buffer area may be deleted, and the processing result of the overlapping data between the data block 546 and the data block 5410 may be stored in the ninth buffer area

When processing data block 547, the processing results in the sixth buffer area and the tenth buffer area may be multiplexed. Then, the data in the sixth buffer area may be deleted, and the processing result of the overlapping data between the data block 547 and the data block 548 may be stored in the sixth buffer area. The processing result in the tenth buffer area may be deleted, and the processing result of the overlapping data between the data block 547 and the data block 5411 may be stored in the tenth buffer area.

When processing data block 548, the processing results in the sixth buffer area and the eighth buffer area may be multiplexed. Then, the processing result in the eighth buffer area may be deleted, and the processing result of the overlapping data between the data block 548 and the data block 5412 may be stored in the eighth buffer area.

It may be seen from the above descriptions that, when the buffer is divided into five multiplexable data buffer areas, each overlapping data between the plurality of data blocks may be multiplexed. Accordingly, the multiplexing rate of the processing results of the overlapping data may reach approximately 100%.

It may be seen from the above descriptions that, by dividing the maximum capacity of the buffer into at least one multiplexable data buffer area, and based on the number of multiplexable data buffer areas, the target processing order corresponding to the plurality of data blocks may be determined. The multiplexing rate of the processing results of the overlapping data of the plurality of data blocks may be improved. Accordingly, the calculation amount of the neural network may be reduced, computing resources may be saved, and the processing speed of the neural network may be improved.

In some embodiments, the above process S4013 may be implemented by the following processes S4014 to S4015.

Process S4014, determining a data multiplexing rate corresponding to each processing order of processing the plurality of data blocks based on the number of the at least one multiplexable data buffer area. The data multiplexing rate represents the multiplexing ratio of the data processing results of the overlapping data among the plurality of data blocks.

In some embodiments, first, a plurality of processing orders for processing the plurality of data blocks may be preset. Then, based on the number of the at least one multiplexable data buffer area, the data multiplexing rate corresponding to each processing order may be calculated respectively. The plurality of processing orders for processing the plurality of data blocks may be determined with reference to the processing orders of the plurality of data blocks shown in FIGS. 5A, 5B, 5C, and 5D.

Process S4015, determining the target processing order based on the data multiplexing rate corresponding to each processing order. The processing order corresponding to the highest data multiplexing rate among the plurality of data multiplexing rates may be taken as the target processing order.

In some embodiments, the target processing order may be determined based on the number of multiplexable data buffer areas and the corresponding processing orders of the plurality of data blocks shown in FIGS. 5A, 5B, 5C, and 5D.

In some embodiments, offline software may be used to determine the target processing order for processing the plurality of data blocks based on the number of the at least one multiplexable data buffer area.

The present disclosure is not limited to using the above processes S4014 to S4015 to determine the target processing order with the highest data multiplexing rate. The present disclosure is also not limited to pre-setting a plurality of processing orders for processing the plurality of data blocks. In some embodiments, the target processing order with the highest data multiplexing rate may be determined by traversing the plurality of data blocks using offline software.

In some embodiments, when the neural network includes a plurality of network layers, for each multiplexable data buffer area, a corresponding buffer address may be allocated to each network layer. For example, as shown in FIG. 2, the multiplexable data buffer area may be used to store overlapping data between two adjacent data blocks.

When processing the data block 211 in the input feature map 210 using the first convolutional layer, the processing result of the overlapping data between the data block 211 and the data block 212 may be stored in the buffer address allocated to the first convolutional layer in the one multiplexable data buffer area.

After obtaining the data block 221 in the intermediate feature map 220 corresponding to the data block 211, when the second convolutional layer is used to process the data block 221, the processing result of the overlapping data between the data block 221 and the data block 222 may be stored in the buffer address allocated to the second convolutional layer in the one multiplexable data buffer area.

In this way, by allocating a corresponding buffer address for each convolutional layer in a multiplexable data buffer area, the processing result of the overlapping data calculated by each convolutional layer may be stored in a determined buffer address. Accordingly, rapid acquisition of multiplexable data may be achieved when processing later-processed data blocks (e.g., data block 212, data block 222).

In some embodiments, the adjacent data blocks of a data block may include: a data block adjacent to the data block along a first direction, and a data block adjacent to the data block along a second direction. The first direction is perpendicular to the second direction.

The multiplexable data amount may include: a first multiplexable data amount between a data block and a data block adjacent to the data block the first direction, and a second multiplexable data amount between a data block and a data block adjacent the data block in the second direction.

The first direction may include, for example, the horizontal direction in FIGS. 5A, 5B, 5C, and 5D. The second direction may include, for example, the vertical direction in FIGS. 5A, 5B, 5C, and 5D.

Two data blocks may be adjacent to each other along the first direction, for example, the data block 211 and the data block 212 in FIG. 2, or two data blocks adjacent to each other horizontally in FIGS. 5A, 5B, 5C, and 5D.

Two data blocks may be adjacent to each other along the second direction, for example, two data blocks vertically adjacent to each other in FIGS. 5A, 5B, 5C, and 5D.

The first multiplexable data amount refers to the sum of data amounts corresponding to processing results of overlapping data corresponding to two data blocks adjacent along the first direction at each network layer. For example, in FIG. 2, the first multiplexable data amount is the sum of the data amounts corresponding to the processing results of the overlapping data corresponding to the horizontally adjacent data blocks 211 and 212 at each convolutional layer. For another example, in FIGS. 5A, 5B, 5C and 5D, the first multiplexable data amount is the sum of the data amounts corresponding to the processing results of the overlapping data corresponding to two horizontally adjacent data blocks at each network layer.

The second multiplexable data amount refers to the sum of data amounts corresponding to processing results of overlapping data corresponding to two adjacent data blocks along the second direction at each network layer. For example, in FIGS. 5A, 5B, 5C and 5D, the second multiplexable data amount is the sum of the data amounts corresponding to the processing results of the overlapping data corresponding to two vertically adjacent data blocks at each network layer.

Thus, the above process S4012 may be implemented by the following processes: based on the maximum storage capacity, the first multiplexable data amount and the second multiplexable data amount, dividing the on-chip buffer into at least one first-type multiplexable data buffer area and at least one second-type multiplexable data buffer area. The first-type multiplexable data buffer is configured to store processing results corresponding to overlapping data between two data blocks adjacent along the first direction. The second-type multiplexable data buffer area is configured to store processing results corresponding to overlapping data between two data blocks adjacent along the second direction.

The first-type multiplexable data buffer area may be used to store processing results corresponding to overlapping data between two data blocks adjacent along the first direction. For example, in FIG. 2, the processing results of the overlapping data corresponding to the data block 211 and the data block 212 at each convolutional layer may be stored in the first-type multiplexable data buffer area. For another example, in FIGS. 5A, 5B, 5C and 5D, the processing results of overlapping data corresponding to two horizontally adjacent data blocks at each network layer may be stored in the first-type multiplexable data buffer area.

The second-type multiplexable data buffer may be used to store the processing results of overlapping data corresponding to two data blocks adjacent to each other in the second direction at each convolutional layer. For example, in FIGS. 5A, 5B, 5C and 5D, the processing results of overlapping data corresponding to two vertically adjacent data blocks at each network layer may be stored in the second-type multiplexable data buffer area.

In some embodiments, when the first multiplexable data amount is equal to the second multiplexable data amount, the first-type multiplexable data buffer area may be same as the second-type multiplexable data buffer area. That is, when the first multiplexable data amount is equal to the second multiplexable data amount, the buffer may be divided into at least one multiplexable data buffer area with equal capacity. A target processing order for processing the plurality of data blocks may be determined based on the number of the at least one multiplexable data buffer area with equal capacity.

In some embodiments, the first multiplexable data amount may not be equal to the second multiplexable data amount. The first-type multiplexable data buffer area may be different from the second-type of multiplexable data buffer area, and the number of the first-type multiplexable data buffer area may be equal to or different from the number of the second-type multiplexable data buffer area. That is, when the first multiplexable data amount is not equal to the second multiplexable data amount, the number of first-type multiplexable data buffer area and the number of second-type multiplexable data buffer area may need to be determined based on the multiplexing rate of the processing result of the overlapping data.

In some embodiments, the first multiplexable data amount is not equal to the second multiplexable data amount. The larger one of the first multiplexable data amount and the second multiplexable data amount may be taken as the target multiplexable data amount. Based on the target multiplexable data amount, the buffer may be divided into at least one multiplexable data buffer area with equal capacity.

In the data processing method provided by the present disclosure, the multiplexable data buffer area may be divided into a first-type multiplexable data buffer area and a second-type multiplexable data buffer area. The buffer division method may be further refined, such that the data amount requirement corresponding to the processing result of overlapping data between adjacent data blocks in different directions may be met. As such, the multiplexing rate of the processing results of the overlapping data of the plurality of data blocks may be improved.

In some embodiments, the neural network is a convolutional neural network. The above process S4011 may be implemented by the following processes: determining the amount of multiplexable data at least based on the number of convolutional layers of the convolutional neural network, the size of the convolutional kernel, and the preset output data size corresponding to the data. The preset output data size is characterized by the data size corresponding to the final processing result obtained through neural network processing based on a result preset for the data.

Based on the preset output data size, the convolution kernel size and the number of channels corresponding to each convolutional layer, the amount of data corresponding to the overlapping data in each convolutional layer may be calculated. In addition, based on the number of convolutional layers of the CNN, the sum of the data amounts corresponding to the processing results of the overlapping data of two adjacent data blocks in each convolutional layer, that is, the amount of multiplexable data corresponding to the process result of the overlapping data between two adjacent data blocks, may be calculated

In some embodiments, the convolution kernel size of the convolutional neural network is K×K. The number of channels corresponding to each convolutional layer is C. The default output feature map size is man, where m is the number of pixels along the vertical direction (i.e., m represents the number of rows of pixels in the output feature map), and n is the number of pixels along the horizontal direction (i.e., n represents the number of columns of pixels in the output feature map). The amount of overlapping data between two adjacent data blocks in the vertical direction, corresponding to each convolutional layer, may be expressed as follows.

The amount of overlapping data f1 in the last convolutional layer (i.e., the processing result of the overlapping data corresponding to the two adjacent data blocks in the second-to-last convolutional layer) may be calculated by the following Equation (1):

$$f 1 = ( K - 1 ) ( n + K - 1 ) C \qquad ( 1 )$$

where (K−1) represents the number of rows corresponding to the overlapping data in the last convolutional layer, and (n+K−1) represents the number of columns corresponding to the overlapping data in the last convolutional layer.

The amount of overlapping data f2 in the second-to-last convolutional layer may be calculated by the following Equation (2):

$$f 2 = 2 ( K - 1 ) [ n + 2 ( K - 1 ) ] C \qquad ( 2 )$$

where 2(K−1) represents the number of rows corresponding to the overlapping data in the second-to-last convolutional layer, and [n+2(K−1)] represents the number of columns corresponding to the overlapping data in the last convolutional layer.

The amount of overlapping data f1 in the l-th-to-last convolutional layer may be calculated using the following Equation (3):

$$fl = l ( K - 1 ) [ n + l ( K - 1 ) ] C \qquad ( 3 )$$

where, l(K−1) represents the number of rows corresponding to the overlapping data in the l-th-to-last convolutional layer, and [n+l(K−1)] represents the number of columns corresponding to the overlapping data in the l-th-to-last convolutional layer.

The sum, Sum₁, of the overlapping data amount corresponding to two vertically adjacent data blocks in each layer may be calculated by the following Equation (4):

$${Sum}_{1} = f {1}_{1} + … + {fl}_{1} + … + {fL}_{1} = [ \frac{( L + 1 ) L}{2} n ( K - 1 ) + \frac{L ( L + 1 ) ( 2 L + 1 )}{6} {( K - 1 )}^{2} ] C \qquad ( 4 )$$

where L is the number of convolutional layers of the CNN network.

Similarly, the sum, Sum₂, of the overlapping data corresponding to two adjacent data blocks in the horizontal direction in each convolution layer may be calculated by the following Equation (5):

$${Sum}_{2} = f {1}_{2} + … + {fl}_{2} + … + {fL}_{2} = [ \frac{( L + 1 ) L}{2} m ( K - 1 ) + \frac{L ( L + 1 ) ( 2 L + 1 )}{6} {( K - 1 )}^{2} ] C \qquad ( 5 )$$

The number of the first-type multiplexable data buffer area and the second-type multiplexable data buffer area may be determined based on the maximum capacity of the buffer S, and the values of Sum₁ and Sum₂.

In some embodiments, when Sum₁=Sum₂, the sum of the number of the first-type multiplexable data buffer area and the number of the second-type multiplexable data buffer area A₁ may be determined based on the following Equation (6):

$${A}_{1} = \frac{S}{{Sum}_{1}} \qquad ( 6 )$$

Then, based on the parity of the quantity A₁, the data amounts in the first-type multiplexable data buffer area and the second-type data buffer area may be determined.

In some embodiments, when Sum₁≠Sum₂, the ratio of the number of the first-type multiplexable data buffer areas to the number of the second-type multiplexable data buffer areas may be preset. Then, based on the preset ratio and the maximum capacity S, the number of first-type multiplexable data buffer areas and the number of second-type multiplexable data buffer areas may be determined respectively.

In some embodiments, when Sum₁≠Sum₂, first, a plurality of preset ratios of the number of first-type multiplexable data buffer areas to the number of second-type multiplexable data buffer areas may be preset. For example, the preset ratios are 1:1, 2:1, 2:3, and so on. Then, based on the plurality of preset ratios and the maximum capacity S, the number of first-type multiplexable data buffer areas and the number of second-type multiplexable data buffer areas corresponding to each preset ratio may be determined respectively. Afterwards, based on the method of processes S4014 to S4015, the data multiplexing rate corresponding to each preset ratio may be determined. Finally, the number of first-category multiplexable data buffer areas and the number of second-category multiplexable data buffer areas corresponding to the maximum data multiplexing rate among the plurality of data multiplexing rates may be determined as the final number of the first-category multiplexable data buffer areas and the number of the second-category multiplexable data buffer areas.

In some embodiments, when Sum₁=Sum₂, the number of the first-type multiplexable data buffer area and the number of the second-type multiplexable data buffer area may also be determined with the above preset ratio method.

In some embodiments, each of the earlier-processed data blocks includes a first sub-data block and at least one second sub-data block. The second sub-data block is an overlapping data block between the earlier-processed data block and an adjacent data block. The processing result of the second sub-data block may be multiplexed by the adjacent data block.

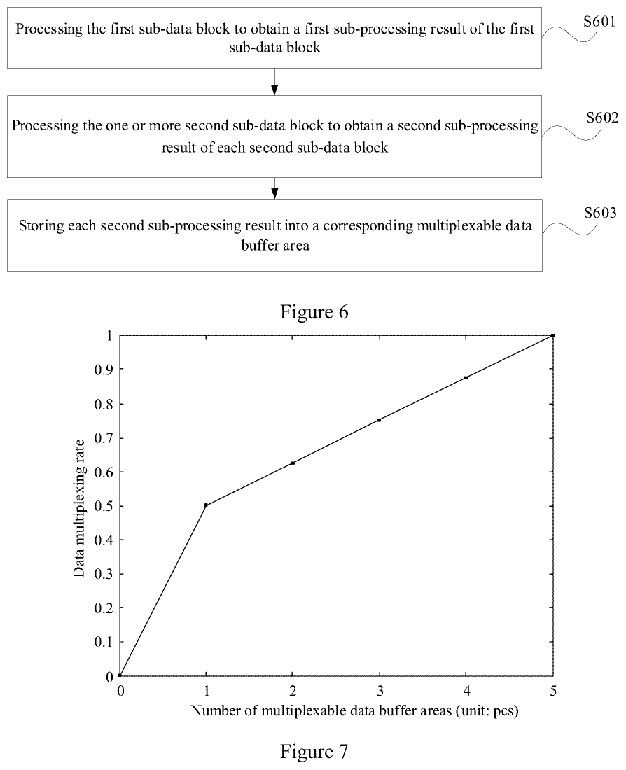

FIG. 6 illustrates an implementation flow chart of processing an earlier-processed data block in a data processing method, consistent with the disclosed embodiments of the present disclosure. As shown in FIG. 6, the method also includes the following processes S601 to S603:

Process S601: processing the first sub-data block to obtain a first sub-processing result of the first sub-data block.

The first sub-data block may be a data block in the earlier-processed data blocks that does not overlap with adjacent data blocks. Alternatively, the first sub-data block may be a data block in the earlier-processed data blocks that overlaps with an adjacent data block, but the processing result thereof may not be multiplexed by the adjacent data block. As such, after processing the first sub-data block, the first sub-processing result may not be stored in the multiplexable data buffer area.

Process S602: processing the at least one second sub-data block to obtain a second sub-processing result of each second sub-data block.

The earlier-processed data block may include one second sub-data block. That is, the earlier-processed data block and the adjacent data block may only multiplex the processing result of one overlapping data. Alternatively, the earlier-processed data block may only multiplex the processing result of the overlapping data with one adjacent data block.

The earlier-processed data block may include two or more second sub-data blocks. That is, the earlier-processed data block may multiplex the processing result of overlapping data with two or more adjacent data blocks.

The second sub-data block may be an overlapping data between an earlier-processed data block and a data block adjacent to the earlier-processed data block along the first direction, for example, the overlapping data between two horizontally adjacent data blocks in FIGS. 5A, 5B, 5C, and 5D. The second sub-data block may also be an overlapping data between an earlier-processed data block and a data block adjacent to the earlier-processed data block along the second direction, for example, the overlapping data between two vertically adjacent data blocks in FIGS. 5A, 5B, 5C, and 5D.

Step S603: storing each of the second sub-processing result into a corresponding multiplexable data buffer area.

The processing result corresponding to each second sub-data block in the earlier-processed data block may be stored in a corresponding multiplexable data buffer area. In addition, in each multiplexable data buffer area, the processing result of a corresponding second sub-data block at a corresponding network layer may be stored according to the buffer address allocated to each network layer.

It should be noted that the processing order of the above processes S601, S602 and S603 is not limited. That is, the first sub-data block may be processed first, and then the at least one second sub-data block may be processed and each second sub-processing result may be stored. Alternatively, the at least one second sub-data block may be processed first and each second sub-processing result may be stored, and then the first sub-data block may be processed.

In some embodiments, according to the target processing order, when the earlier-processed data block is the first processed data block, each data of the earlier-processed data block is read from the off-chip memory.

In some embodiments, the later-processed data block may include a third sub-data block and at least one fourth sub-data block. Each of the fourth sub-data block is a target sub-data block overlapping with a second sub-data block in an adjacent earlier-processed data block.

In the above process S402, the processing of the later-processed data block may be implemented by the following processes S4021 to S4023.

Process S4021: processing the third sub-data block to obtain a third sub-processing result of the third sub-data block. The third sub-data block is a data block in the later-processed data block, and the third sub-data block does not overlap with any second sub-data block in an adjacent earlier-processed data block.

In some embodiments, when the later-processed data block is processed using the first network layer of the neural network, the method also includes: acquiring the third sub-data block from an off-chip memory.

The at least one fourth sub-data block is a data block overlapping with a second sub-data block in an adjacent data block, and the processing result of the second sub-data block may be directly multiplexed. As such, in some embodiments of the present disclosure, for the later-processed data block, the third sub-data block may be acquired only from the off-chip memory, and there is no need to reacquire the at least one fourth sub-data block. For example, in the input feature map 210 shown in FIG. 2, for the later-processed data block 212, only the sub-data block 213 needs to be obtained from the off-chip memory. In this way, the amount of data read from the off-chip memory may be reduced, the access to the off-chip memory may be reduced, and the data processing speed may be improved.

Step S4022: acquiring, from a corresponding storage area in the multiplexable data buffer, a second sub-processing result corresponding to the second sub-data block overlapping with each of the target sub-data blocks. The corresponding storage area in the multiplexable data buffer area refers to a storage area for storing the second sub-processing result corresponding to the second sub-data block overlapping with the target sub-data block, for example, the buffer address corresponding to a specified network layer in the multiplexable data buffer area corresponding to the second sub-data block.

Process S4023: merging the third sub-processing result and the second sub-processing result of each target sub-data block as the processing result of the later-processed data block.

The third sub-processing result and the second sub-processing result of each target sub-data block may be combined as a processing result corresponding to the later-processed data block. The processing result corresponding to the later-processed data block may be further processed as an input data corresponding to the later-processed data block in the next network layer, or may be output as the output data corresponding to the later-processed data block in the output data.

The technical effects of the data processing method provided by the present disclosure in neural network calculation are explained below with reference to FIGS. 7 to 9.

FIG. 7 illustrates a schematic diagram showing a corresponding relationship between a quantity of multiplexable data buffers and a data multiplexing rate in a data processing method, consistent with the disclosed embodiments of the present disclosure. It may be seen that the larger the maximum storage capacity of the buffer and the more multiplexable data buffer areas are divided, the higher the data multiplexing rate of the plurality of data blocks. In particular, when the buffer is divided into five multiplexable data buffer areas, the data multiplexing rate may be increased to approximately 100%.

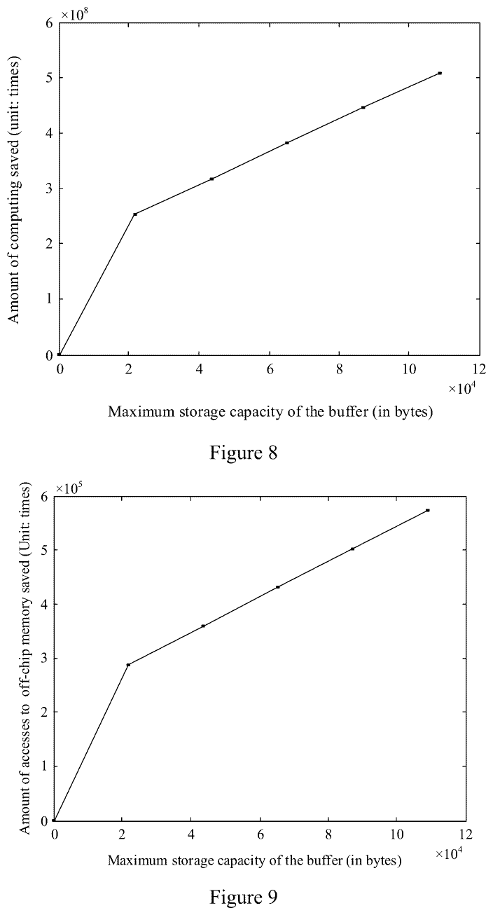

FIG. 8 illustrates a schematic diagram of a corresponding relationship between a maximum storage capacity of a buffer and an amount of computation saved in a data processing method consistent with the disclosed embodiments of the present disclosure. It may be seen that the larger the maximum storage capacity of the buffer, the larger the amount of data that may be multiplexed, and thus the larger the amount of computation that may be saved.

FIG. 9 illustrates a schematic diagram of a corresponding relationship between a maximum storage capacity of a buffer and an amount of access to an off-chip memory saved in a data processing method, consistent with the disclosed embodiments of the present disclosure. It may be seen that the larger the maximum storage capacity of the buffer is, the larger the amount of data that may be multiplexed is, and thus the larger the amount of access to the off-chip memory that may be saved is.

In one embodiment, the CNN is used as the neural network to process data. The convolution kernel size is 3×3 (in pixels), that is, K=3. The number of convolutional layers L is 5, and the number of channels in each convolutional layer C is 64. The default output feature map size is m×n=4×4 (in pixels), and the input feature map includes 4×8 (i.e., 4 rows and 8 columns) data blocks. Part of the technical effects brought about by the data processing method provided by the present disclosure are described below.

In the process of extracting features from the input feature map using the data processing method provided by the present disclosure, when the buffer may store the processing result of one overlapping data, in an achievable target processing order, the processing results of 32 overlapping data blocks may be multiplexed.

When the buffer may store the processing results of two overlapping data, in an achievable target processing order, the processing results of 40 overlapping data blocks may be multiplexed.

The data amount Sum corresponding to the processing result of each overlapping data block may be calculated as:

$$\begin{matrix}Sum = [ \frac{( L + 1 ) L}{2} n ( K - 1 ) + \frac{L ( L + 1 ) ( 2 L + 1 )}{6} {( K - 1 )}^{2} ] C \\ = [ \frac{( 5 + 1 ) \times 5}{2} \times 4 \times ( 3 - 1 ) + \frac{5 \times ( 5 + 1 ) \times ( 2 \times 5 + 1 )}{6} \times {( 3 - 1 )}^{2} ] \times 64 \\ = 21760\end{matrix}$$

In the process of extracting features from the input feature map using existing technology: firstly, each sub-data block in each data block in the input feature map needs to be read from the off-chip memory; Secondly, intermediate feature maps each need to be calculated through the convolutional layer.

For each overlapping pixel between adjacent data blocks, the required amount of calculation is K×K×C=3×3×64=576. The amount of access to the off-chip memory for each overlapping data block is:

$$L ( K - 1 ) [ n + L ( K - 1 ) ] C = 5 \times ( 3 - 1 ) \times [ 4 + 5 \times ( 3 - 1 ) ] \times 64 = 8960$$

The amount of calculation, Sum′, required for each overlapping data block may be calculated as:

$$\begin{matrix}{Sum}^{′} = [ \frac{( n + 1 ) n}{2} n ( K - 1 ) + \frac{n ( n + 1 ) ( 2 n + 1 )}{6} {( K - 1 )}^{2} ] * C * 576 \\ = [ \frac{( 4 + 1 ) \times 4}{2} 4 \times ( 3 - 1 ) + \frac{4 \times ( 4 + 1 ) \times ( 2 \times 4 + 1 )}{6} ] \times {( 3 - 1 )}^{2} \times 64 \times 576 \\ = 7948800\end{matrix}$$

It may be learnt, from the above descriptions and FIGS. 8 and 9, that one byte of buffer space may save 11,689 calculations and 13 accesses to off-chip memory. The resources saved outweigh the storage resource cost of the buffer. Accordingly, the data processing method provided by the present disclosure may reduce the amount of calculation and the amount of access to the off-chip memory in data processing, and reduce power consumption.

The present disclosure provides a data processing device. The device, each unit included in the device, and each module included in each unit, may be implemented by a processor in a computer device, and may also be implemented by a specific logic circuit. During implementation, the processor may be a central processing unit (CPU), a microprocessor (MPU), a digital signal processor (DSP), or a field programmable gate array (FPGA).

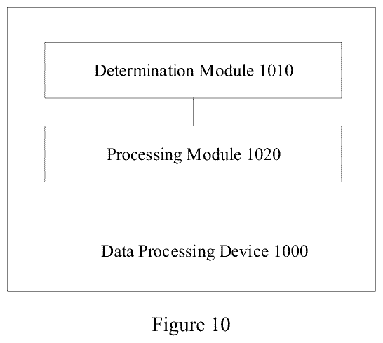

FIG. 10 illustrates a schematic structural diagram of a data processing device consistent with the disclosed embodiments of the present disclosure. As shown in FIG. 10, the data processing device 1000 may include a determination module 1010 and a processing module 1020.

The determination module 1010 is configured to determine the target processing order for processing the plurality of data blocks in the data based on the maximum storage capacity of the buffer. The data may be divided into the plurality of data blocks for separate processing, and there may be overlapping data between adjacent data blocks.

The processing module 1020 is configured to process the plurality of data blocks in sequence using a neural network based on the target processing order. At least part of the processing result of the later-processed data block is a multiplexing of the processing result corresponding to the overlapping data between the later-processed data block and at least one earlier-processed data block adjacent to the later-processed data block. In some embodiments, the neural network includes at least one network layer.

The determination model 1010 includes a first sub-determination module 1011, a division module 1012, and a second sub-determination module 1013.

The first sub-determination module 1011 is configured to determine the multiplexable data amount corresponding to the result multiplexed by one data block of the plurality of data blocks with adjacent data blocks. The multiplexable data amount represents the sum of the data amounts corresponding to the processing results of the overlapping data corresponding to the one data block and the adjacent data blocks at each of the network layers.

The division module 1012 is configured to divide the buffer into at least one multiplexable data buffer area based on the maximum storage capacity and the amount of multiplexable data.

The second sub-determination module 1013 is configured to determine the target processing order for processing the plurality of data blocks in the data based on the number of the at least one multiplexable data buffer area.

In some embodiments, the adjacent data blocks of a data block may include: a data block adjacent to the data block along a first direction, and a data block adjacent to the data block along a second direction. The first direction is perpendicular to the second direction.

The multiplexable data amount may include: a first multiplexable data amount between a data block and a data block adjacent to the data block the first direction, and a second multiplexable data amount between a data block and a data block adjacent the data block in the second direction.

The first sub-determining module 1011 is configured to, based on the maximum storage capacity, the first multiplexable data amount and the second multiplexable data amount, divide the on-chip buffer into at least one first-type multiplexable data buffer area and at least one second-type multiplexable data buffer area. The first-type multiplexable data buffer is configured to store processing results corresponding to overlapping data between two data blocks adjacent along the first direction. The second-type multiplexable data buffer area is configured to store processing results corresponding to overlapping data between two data blocks adjacent along the second direction.

In some embodiments, the neural network is a convolutional neural network.

The first sub-determining module 1011 is configured to determine the amount of multiplexable data based on the number of convolutional layers of the convolutional neural network, the size of the convolutional kernel, and the preset output data size corresponding to the data. The preset output data size is characterized by the data size corresponding to the final processing result obtained through neural network processing based on a result preset for the data.

In some embodiments, the second sub-determining module 1013 is configured to determine a data multiplexing rate corresponding to each processing order of processing the plurality of data blocks based on the number of the at least one multiplexable data buffer area. The data multiplexing rate represents the multiplexing ratio of the data processing results of the overlapping data among the plurality of data blocks.

The second sub-determining module 1013 is also configured to determine the target processing order based on the data multiplexing rate corresponding to each processing order.

In some embodiments, each of the earlier-processed data blocks includes a first sub-data block and at least one second sub-data block. The second sub-data block is an overlapping data block between the earlier-processed data block and an adjacent data block. The processing result of the second sub-data block may be multiplexed by the adjacent data block.

The processing module 1020 is also configured to: process the first sub-data block to obtain a first sub-processing result of the first sub-data block; process the at least one second sub-data block to obtain a second sub-processing result of each second sub-data block; and store each of the second sub-processing result into a corresponding multiplexable data buffer area.

In some embodiments, the later-processed data block may include a third sub-data block and at least one fourth sub-data block. Each of the fourth sub-data block is a target sub-data block overlapping with a second sub-data block in an adjacent earlier-processed data block.

The processing module 1020 is also configured to: process the third sub-data block to obtain a third sub-processing result of the third sub-data block; acquire, from a corresponding storage area in the multiplexable data buffer area, a second sub-processing result corresponding to the second sub-data block overlapping with each of the target sub-data blocks; merge the third sub-processing result and the second sub-processing result of each target sub-data block as the processing result of the later-processed data block.

In some embodiments, when the later-processed data block is processed using the first network layer of the neural network, the processing module 1020 is also configured to obtain the third sub-data block from the off-chip memory.

In some embodiments, the neural network includes a plurality of network layers. The plurality of data blocks includes a plurality of initial data blocks.

The processing module 1020 is also configured to, for each of the initial data blocks, use the plurality of network layers to process the initial data blocks in sequence to obtain a processing result corresponding to the initial data block at each of the network layers. Adjacent initial data blocks may have overlapping data between the processing results corresponding to each network layer.

For implementation details and beneficial effects of the data processing device, reference may be made to the descriptions of the data processing method in the present disclosure, which will not be elaborated here.

It should be noted that, in the present disclosure, when the data processing method is implemented in the form of a software functional module and sold or used as an independent product, the method may also be stored in a computer-readable storage medium. Based on this understanding, the essential technical solution of the present disclosure, or the part that contributes to the relevant technology, may be implemented in the form of a computer software product. The software product may be stored in a storage medium, and may include a plurality of instructions for making an electronic device (which may be a mobile phone, tablet computer, laptop computer, desktop computer, etc.) to execute each or part of the processes of the method provided by the present disclosure. The storage medium may include U disk, mobile hard disk, read only memory (ROM), magnetic disk, optical disk, and other media that may store program code. The present disclosure is not limited to any specific hardware, software or firmware, or any combination of hardware, software and firmware.

The present disclosure provides a computer device, including a memory and a processor. The memory stores a computer program that may be executed by the processor. When the processor executes the program, part of or each of the processes in the data processing method may be implemented.

The present disclosure provides a computer-readable storage medium with a computer program stored thereon. When the processor executes the program, part of or each of the processes in the data processing method may be implemented. The computer-readable storage medium may be transitory or non-transitory.

The present disclosure provides a computer program, including computer readable code. When the computer-readable code runs in a computer device, a processor in the computer device may execute part of or each of the processes for implementing the data processing method provided by the present disclosure.

The present disclosure provides a computer program product. The computer program product may include a non-transitory computer-readable storage medium storing a computer program. When the computer program is read and executed by a computer, part of or each of the processes in the method provided by the present disclosure may be implemented. The computer program product may be implemented in hardware, software or a combination thereof. In some embodiments, the computer program product may be embodied as a computer storage medium. In some other embodiments, the computer program product may be specifically embodied as a software product, such as a software development kit (SDK) and the like.

In the present disclosure, descriptions of various embodiments tend to emphasize the differences between the embodiments, and the same or similar aspects thereof may be referenced to each other. The descriptions of the embodiments of the above device, storage medium, computer program, and computer program product, are similar to the descriptions of the embodiments of the data processing method. For implementation details and beneficial effects of the device, storage medium, computer program, and computer program product, reference may be made to the descriptions of the data processing method in the present disclosure, which will not be elaborated here.

In the present disclosure, the embodiments described are merely illustrative. It should be understood that the disclosed devices and methods may be implemented in other ways. For example, the unit division is only a logical function division, and there may be other division methods in actual implementation. A plurality of units or components may be combined, or may be integrated into another system, and some features may be ignored or not performed. In addition, the coupling, direct coupling, or communication connection between the components may be achieved through interfaces, indirect couplings or communication connections of devices, components or units. The interfaces, indirect couplings or communication connections may be electrical, mechanical or other forms.

In the present disclosure, the units described as separate components may or may not be physically separate, and the components shown as units may or may not be physical units. The components and units may be located in one place or distributed across a plurality of network units. Each or a part of the components and units may be selected according to actual needs to achieve the purposes of the present disclosure.

In addition, each of the functional units in an embodiment of the present disclosure may be integrated into one processing unit, or each functional unit may separately operate as a processing unit, or two or more functional units may be integrated into one processing unit. The integrated processing unit may be implemented in the form of hardware, or in the form of hardware plus software functional units.

Those skilled in the art may understand that, each or part of the processes of the method provided by the present disclosure may be completed by hardware related to program instructions. The program may be stored in a computer-readable storage medium. When the program is executed, the processes of the method may be performed. The storage medium may include a mobile storage device, read-only memory (ROM), magnetic disk or optical disk, and other media that may store program codes.

When the integrated unit of the present disclosure is implemented in the form of a software function module and sold or used as an independent product, the integrated unit may also be stored in a computer-readable storage medium. Based on this understanding, the technical solution of the present disclosure, or the part that contributes to the relevant technology, may essentially be embodied in the form of a software product. The computer software product may be stored in a storage medium, and may include a plurality of instructions. The plurality of instructions may make an electronic device (which may be a mobile phone, tablet computer, laptop computer, desktop computer, etc.) to execute each or part of the processes of the method provided by the present disclosure. The storage medium may include a mobile storage device, ROM, magnetic disk, optical disk, and other medium that may store program codes.

As disclosed, the technical solutions of the present disclosure have the following advantages.

In the data processing method provided in the present disclosure, the target processing order for processing the plurality of data blocks in the data may be determined based on the maximum storage capacity of the buffer. Based on the target processing order, the plurality of data blocks may be processed in sequence using a neural network. At least part of the processing result of the later-processed data block is a multiplexing of the processing result corresponding to the overlapping data between the later-processed data block and at least one earlier-processed data block adjacent to the later-processed data block. Thus, on one hand, in the process of processing the plurality of data blocks, at least part of the processing result of the later-processed data block is a multiplexing of the processing result corresponding to the overlapping data between the later-processed data block and at least one earlier-processed data block adjacent to the later-processed data block. Accordingly, repeated calculations of the overlapping data between adjacent data blocks may be reduced, and the purpose of saving computing resources may be achieved. In addition, the number of times of accessing data from the off-chip memory may be reduced, and the data processing speed may thus be increased. On the other hand, the target processing order of the plurality of data blocks may be determined based on the maximum storage capacity of the buffer. That is, the processing order of the plurality of data blocks may be determined by determining the amount of processing results corresponding to the overlapping data that may be stored in the buffer. Accordingly, the multiplexing rate of the processing results of overlapping data may be improved, computing efficiency may be improved, and computing resources may be saved.

The embodiments disclosed in the present disclosure are exemplary only and not limiting the scope of the present disclosure. Various combinations, alternations, modifications, or equivalents to the technical solutions of the disclosed embodiments may be obvious to those skilled in the art and may be included in the present disclosure. Without departing from the spirit of the present disclosure, the technical solutions of the present disclosure may be implemented by other embodiments, and such other embodiments are intended to be encompassed within the scope of the present disclosure.

What is claimed is:

1. A data processing method, comprising:
determining a target processing order for processing a plurality of data blocks in data, based on maximum storage capacity of a buffer, wherein the data is divided into the plurality of data blocks for separate processing, and adjacent data blocks in the plurality of data blocks have overlapping data; and
sequentially processing the plurality of data blocks using a neural network based on the target processing order, wherein at least a part of a processing result of a later-processed data block of the plurality of data blocks is a multiplexing of a processing result corresponding to the overlapping data between the later-processed data block and one or more earlier-processed data blocks of the plurality of data blocks, adjacent to the later-processed data block.

2. The method according to claim 1, wherein the neural network includes one or more network layers, and determining the target processing order for processing the plurality of data blocks in the data, based on the maximum storage capacity of the buffer, includes:
determining a multiplexable data amount corresponding to a process result multiplexed by a data block and an adjacent data block of the data block, in the plurality of data blocks, wherein the multiplexable data amount represents a sum of data amounts corresponding to the processing result of the overlapping data corresponding to the data block and the adjacent data block at each of the one or more network layers;
dividing the buffer into one or more multiplexable data buffer areas, based on the maximum storage capacity and the multiplexable data amount; and
determining the target processing order for processing the plurality of data blocks in the data, based on a quantity of the one or more multiplexable data buffer areas.

3. The method according to claim 2, wherein:
the adjacent data blocks include: data blocks of the plurality of data blocks, adjacent along a first direction, and data blocks of the plurality of data blocks, adjacent along a second direction, wherein the first direction is perpendicular to the second direction; and
the multiplexable data amount includes: a first multiplexable data amount between the data blocks adjacent along the first direction, and a second multiplexable data amount between the data blocks adjacent along the second direction.

4. The method according to claim 3, wherein dividing the buffer into the one or more multiplexable data buffer areas, based on the maximum storage capacity and the multiplexable data amount, includes:
dividing an on-chip buffer of the buffer into one or more first-type multiplexable data buffer areas and one or more second-type multiplexable data buffer areas, based on the maximum storage capacity, the first multiplexable data amount and the second multiplexable data amount, wherein:
the one or more first-type multiplexable data buffers are configured to store a processing result corresponding to an overlapping data between two data blocks of the plurality of data blocks, adjacent along the first direction; and
the one or more second-type multiplexable data buffer areas are configured to store a processing result corresponding to an overlapping data between two data blocks of the plurality of data blocks, adjacent along the second direction.

5. The method according to claim 2, wherein the neural network includes a convolutional neural network, and determining the multiplexable data amount corresponding to the process result multiplexed by the data block and the adjacent data block of the data block, in the plurality of data blocks, includes:
determining the multiplexable data amount, based on a quantity of convolutional layers of the convolutional neural network, a size of a convolutional kernel, and a preset output data size corresponding to the data, wherein the preset output data size is characterized by a data size corresponding to a final processing result obtained through neural network processing based on a preset data size.

6. The method according to claim 2, wherein determining the target processing order for processing the plurality of data blocks in the data, based on the quantity of the one or more multiplexable data buffer areas, includes:
determining a data multiplexing rate corresponding to each processing order of processing the plurality of data blocks based on the quantity of the one or more multiplexable data buffer areas, wherein the data multiplexing rate represents a multiplexing ratio of the processing result of the overlapping data in the plurality of data blocks; and
determining the target processing order based on the data multiplexing rate corresponding to each processing order.

7. The method according to claim 1, wherein:
each of the earlier-processed data blocks include a first sub-data block and one or more second sub-data blocks, wherein:
a second sub-data block of the one or more second sub-data blocks is an overlapping data block between an earlier-processed data block of the one or more earlier-processed data blocks and an adjacent data block of the earlier-processed data block; and
a processing result of the second sub-data block is multiplexed by the adjacent data block.

8. The method according to claim 7, further comprising:
processing the first sub-data block to obtain a first sub-processing result of the first sub-data block;
processing the one or more second sub-data blocks to obtain a second sub-processing result of each second sub-data block of the one or more second sub-data blocks; and
storing each second sub-processing result into a multiplexable data buffer area corresponding to the second sub-processing result.

9. The method according to claim 8, wherein:
the later-processed data block includes a third sub-data block and one or more fourth sub-data blocks, wherein each of the one or more fourth sub-data blocks is a target sub-data block overlapping with the second sub-data block in the earlier-processed data block adjacent to the later-processed data block.

10. The method according to claim 9, wherein processing the later-processed data block includes:
processing the third sub-data block to obtain a third sub-processing result of the third sub-data block;
acquiring, from a corresponding storage area in the multiplexable data buffer area, a second sub-processing result corresponding to a second sub-data block of the one or more second sub-data block overlapping with each of the target sub-data blocks; and
merging the third sub-processing result and the second sub-processing result of each target sub-data block to obtain the processing result of the later-processed data block.

11. The method according to claim 10, wherein:
when the later-processed data block is processed using a first network layer of the neural network, the method further includes acquiring the third sub-data block from an off-chip memory.

12. The method according to claim 1, wherein:
the neural network includes a plurality of network layers, and the plurality of data blocks include a plurality of initial data blocks; and
sequentially processing the plurality of data blocks includes:
for each initial data block of the plurality of initial data blocks, using the plurality of network layers to process the initial data block in sequence to obtain a processing result corresponding to the initial data block at each of the plurality of network layers, wherein the processing results corresponding to adjacent initial data blocks of the plurality of initial data blocks at each of the plurality of network layers have overlapping data.

13. A data processing device, comprising:
a determination module, configured to determine a target processing order for processing a plurality of data blocks in data, based on maximum storage capacity of a buffer, wherein the data is divided into the plurality of data blocks for separate processing, and adjacent data blocks in the plurality of data blocks have overlapping data; and
a processing module, configured to sequentially process the plurality of data blocks using a neural network based on the target processing order, wherein at least a part of a processing result of a later-processed data block of the plurality of data blocks is a multiplexing of a processing result corresponding to the overlapping data between the later-processed data block and one or more earlier-processed data blocks of the plurality of data blocks, adjacent to the later-processed data block.

14. An electronic device comprising one or more processors configured to execute the data processing device according to claim 13.

15. The device according to claim 14, wherein the neural network includes one or more network layers, and the one or more processors are further configured to perform:
determining a multiplexable data amount corresponding to a process result multiplexed by a data block and an adjacent data block of the data block, in the plurality of data blocks, wherein the multiplexable data amount represents a sum of data amounts corresponding to the processing result of the overlapping data corresponding to the data block and the adjacent data block at each of the one or more network layers;
dividing the buffer into one or more multiplexable data buffer areas, based on the maximum storage capacity and the multiplexable data amount; and
determining the target processing order for processing the plurality of data blocks in the data, based on a quantity of the one or more multiplexable data buffer areas.

16. The device according to claim 15, wherein:
the adjacent data blocks include: data blocks of the plurality of data blocks, adjacent along a first direction, and data blocks of the plurality of data blocks, adjacent along a second direction, wherein the first direction is perpendicular to the second direction; and
the multiplexable data amount includes: a first multiplexable data amount between the data blocks adjacent along the first direction, and a second multiplexable data amount between the data blocks adjacent along the second direction.

17. The device according to claim 16, wherein the one or more processors are further configured to perform:
dividing an on-chip buffer of the buffer into one or more first-type multiplexable data buffer areas and one or more second-type multiplexable data buffer areas, based on the maximum storage capacity, the first multiplexable data amount and the second multiplexable data amount, wherein:
the one or more first-type multiplexable data buffers are configured to store a processing result corresponding to an overlapping data between two data blocks of the plurality of data blocks, adjacent along the first direction; and
the one or more second-type multiplexable data buffer areas are configured to store a processing result corresponding to an overlapping data between two data blocks of the plurality of data blocks, adjacent along the second direction.

18. The device according to claim 15, wherein the neural network includes a convolutional neural network, and the one or more processors are further configured to perform:
determining the multiplexable data amount, based on a quantity of convolutional layers of the convolutional neural network, a size of a convolutional kernel, and a preset output data size corresponding to the data, wherein the preset output data size is characterized by a data size corresponding to a final processing result obtained through neural network processing based on a preset data size.

19. The device according to claim 15, wherein the one or more processors are further configured to perform:
determining a data multiplexing rate corresponding to each processing order of processing the plurality of data blocks based on the quantity of the one or more multiplexable data buffer areas, wherein the data multiplexing rate represents a multiplexing ratio of the processing result of the overlapping data in the plurality of data blocks; and
determining the target processing order based on the data multiplexing rate corresponding to each processing order.

20. A non-transitory computer readable storage medium containing computer program that, when being executed, causes at least one processor to perform:
determining a target processing order for processing a plurality of data blocks in data, based on maximum storage capacity of a buffer, wherein the data is divided into the plurality of data blocks for separate processing, and adjacent data blocks in the plurality of data blocks have overlapping data; and
sequentially processing the plurality of data blocks using a neural network based on the target processing order, wherein at least a part of a processing result of a later-processed data block of the plurality of data blocks is a multiplexing of a processing result corresponding to the overlapping data between the later-processed data block and one or more earlier-processed data blocks of the plurality of data blocks, adjacent to the later-processed data block.
